(19) United States
(12) Patent Application Publication
(10) Pub. No.: US 2014/0311534 A1
(43) Pub. Date: Oct. 23, 2014

(54) CLEANING METHOD AND CLEANING DEVICE FOR SEALING MASK, AND PRODUCTION METHOD FOR HONEYCOMB STRUCTURE

(71) Applicant: SUMITOMO CHEMICAL COMPANY, LIMITED, Chuo-ku, Tokyo (JP)

(72) Inventors: Masaharu Mori, Niihama-shi (JP); Ying Gong, Niihama-shi (JP)

(73) Assignee: SUMITOMO CHEMICAL COMPANY, LIMITED, Chuo-ku, Tokyo (JP)

(21) Appl. No.: 14/366,167

(22) PCT Filed: Dec. 13, 2012
(86) PCT No.: PCT/JP2012/082348

§ 371 Date: Jun. 17, 2014

(30) Foreign Application Priority Data
Dec. 19, 2011 (JP) 2011-277676

(51) Int. Cl. B08B 3/02

(52) U.S. Cl. CPC B08B 3/02
USPC 134/157; 134/33

(57) ABSTRACT

A sealing mask has a pair of principal surfaces opposed to each other and a plurality of through-holes opening in the pair of principal surfaces and is used for sealing predetermined cells out of a plurality of cells in a honeycomb structure. A cleaning device for the sealing mask is provided with: a rotator configured to support the sealing mask and rotate the sealing mask around a central axis L1 intersecting with the pair of principal surfaces; and a sprayer having a nozzle for spraying a cleaning liquid on one of the principal surfaces.

### TECHNICAL FIELD

The present invention relates to a cleaning method and a cleaning device for a sealing mask used for sealing predetermined cells out of a plurality of cells in a honeycomb structure, and a production method for the honeycomb structure.

### BACKGROUND ART

The honeycomb structure is widely known for use as a filter for cleaning up gas emitted from an internal combustion engine, e.g., for use as a DPF (Diesel particulate filter). The honeycomb structure has a structure in which each of cells is arranged so that a cell plugged at one end by a sealing material is adjacent to at least one cell plugged at the other end by the sealing material.

A sealing mask provided with through-holes at locations corresponding to the cells to be plugged is used for sealing only the predetermined cells by the sealing material at the ends of the honeycomb structure. The following Patent Literatures 1 and 2 describe methods for sealing the honeycomb structure with the use of the sealing mask.

### CITATION LIST

### Patent Literatures

Patent Literature 1: Japanese Patent Application Laid-Open Publication No. 2004-290766

Patent Literature 2: Japanese Patent Application Laid-Open Publication No. 2008-132749

### SUMMARY OF INVENTION

### Technical Problem

The sealing mask used for sealing the honeycomb structure is cleaned for removing extraneous substances attached thereto (e.g., the sealing material left thereon, dust in air, and so on) and is then reused. For making a plugged state of the honeycomb structure stable, adequate removal of the extraneous substances is required in the cleaning of the sealing mask. On the other hand, reduction in time for the cleaning of the sealing mask is required for enhancing production efficiency of the honeycomb structure.

It is therefore an object of the present invention to provide a cleaning method and a cleaning device for a sealing mask, and a production method for a honeycomb structure which can adequately remove the extraneous substances in a short time.

### Solution to Problem

A cleaning method for a sealing mask according to the present invention is a method for cleaning a sealing mask having one principal surface and the other principal surface opposed to each other and a plurality of through-holes opening in the one principal surface and the other principal surface, the sealing mask for sealing a predetermined cell out of a plurality of cells in a honeycomb structure, the method comprising: spraying a cleaning liquid on at least the one principal surface, while rotating the sealing mask around an axis intersecting with the one principal surface and the other principal surface.

In this cleaning method, the sealing mask is rotated around the axis intersecting with the one principal surface and the other principal surface, whereby the liquid is evenly sprayed over the whole of at least the one principal surface of the sealing mask. In addition, since a rotating speed of the sealing mask is added to a moving speed of the liquid, a force exerted on the extraneous substances by collision of the liquid is enhanced. Furthermore, the liquid and extraneous substances are blown away by centrifugal force to the outside of the sealing mask. Therefore, the extraneous substances can be adequately removed in a short time.

The liquid may be sprayed on each of the one principal surface and the other principal surface, whereby the extraneous substances can be adequately removed in a shorter time.

Furthermore, the liquid may be sprayed on each of the one principal surface and the other principal surface so that a region sprayed with the liquid on the one principal surface and a region sprayed with the liquid on the other principal surface deviate from each other when viewed from a direction parallel to the axis. In this cleaning method, the liquid can be simultaneously sprayed on the wider regions when viewed from the direction parallel to the axis, whereby the extraneous substances can be adequately removed in a shorter time.

Furthermore, the liquid may be sprayed on at least the one principal surface so that a drag acts on the rotating sealing mask. In this cleaning method, since a moving direction of the extraneous substances attached to the sealing mask is made opposite to a moving direction of the liquid, the force exerted on the extraneous substances by collision of the liquid is further enhanced. Therefore, the extraneous substances can be adequately removed in a shorter time.

Furthermore, after spraying the liquid on at least the one principal surface, a gas for removal of the liquid may be sprayed on at least the one principal surface, while the sealing mask is rotated around the axis. In this cleaning method, the sealing mask is rotated around the axis intersecting with the one principal surface and the other principal surface, whereby the gas is evenly sprayed over the whole of at least the one principal surface of the sealing mask. In addition, since the rotating speed of the sealing mask is added to a moving speed of the gas, a force exerted on the liquid by the spraying of the gas is enhanced. Furthermore, the liquid is blown away by centrifugal force to the outside of the sealing mask. Therefore, the liquid remaining on the sealing mask can be removed in a short time.

A production method for a honeycomb structure according to the present invention comprises: sealing the predetermined cell in the honeycomb structure, using the sealing mask cleaned with the use of the cleaning method for the sealing mask as described above. Since this production method uses the sealing mask from which the extraneous substances have been adequately removed by the aforementioned cleaning method, it can make a plugged state of the honeycomb structure stable. In addition, since the extraneous substances are removed in a short time by the foregoing cleaning method, a time for awaiting completion of the cleaning of the sealing mask becomes shorter and thus the production efficiency of the honeycomb structure can be enhanced.

A cleaning device according to the present invention is a device for cleaning a sealing mask. The sealing mask has one principal surface and the other principal surface opposed to each other and a plurality of through-holes opening in the one principal surface and the other principal surface and is used for sealing a predetermined cell out of a plurality of cells in a honeycomb structure. The cleaning device for the sealing mask comprises: a rotator configured to support the sealing mask and rotate the sealing mask around an axis intersecting with the one principal surface and the other principal surface; and a sprayer having a first nozzle for spraying a cleaning liquid on the one principal surface.

This cleaning device can spray the liquid from the first nozzle of the sprayer while the rotator rotates the sealing mask around the axis intersecting with the one principal surface and the other principal surface. By this, the liquid is evenly sprayed over the whole of the one principal surface. In addition, since the rotating speed of the sealing mask is added to the moving speed of the liquid, the force exerted on the extraneous substances by collision of the liquid is enhanced. Furthermore, the liquid and extraneous substances are blown away by centrifugal force to the outside of the sealing mask. Therefore, the extraneous substances can be adequately removed in a short time.

The sprayer may further have a second nozzle for spraying the liquid on the other principal surface, so that the liquid can be sprayed on each of the one principal surface and the other principal surface, whereby the extraneous substances can be adequately removed in a shorter time.

Furthermore, the first nozzle and the second nozzle may spray the liquid on the one principal surface and on the other principal surface, respectively, so that a region sprayed with the liquid on the one principal surface and a region sprayed with the liquid on the other principal surface deviate from each other when viewed from a direction parallel to the axis. This cleaning device can make the liquid simultaneously reaching the wider range when viewed from the direction parallel to the axis, whereby the extraneous substances can be adequately removed in a shorter time.

Furthermore, the first nozzle and the second nozzle may be arranged at mutually different positions when viewed from the direction parallel to the axis. This production device can realize, by the simple configuration, the state in which the region sprayed with the liquid on the one principal surface and the region sprayed with the liquid on the other principal surface deviate when viewed from the direction parallel to the axis.

Furthermore, at least the first nozzle may spray the liquid on the one principal surface so that a drag acts on the rotating sealing mask. Since this cleaning device makes the moving direction of the extraneous substances attached to the sealing mask, opposite to the moving direction of the liquid, the force exerted on the extraneous substances by collision of the liquid is further enhanced. Therefore, the extraneous substances can be adequately removed in a shorter time.

Furthermore, the sprayer may further have a third nozzle for spraying a gas for removal of the liquid, on at least the one principal surface. This cleaning device is configured, after the spraying of the liquid, to make the third nozzle spray the gas on the one principal surface while the sealing mask is rotated by the rotator. By this, the gas is evenly sprayed over the whole of at least the one principal surface of the sealing mask. In addition, since the rotating speed of the sealing mask is added to the moving speed of the gas, the force exerted on the liquid by the spraying of the gas is enhanced. Furthermore, the liquid is blown away by centrifugal force to the outside of the sealing mask. Therefore, the liquid remaining on the sealing mask can be removed in a short time.

Furthermore, the sprayer may further have a switching device for implementing switching between a liquid spraying state in which the liquid is sprayed from at least the first nozzle and a gas spraying state in which a gas for removal of the liquid is sprayed from at least the first nozzle. This cleaning device is configured to make the switching device implement the switching between the liquid splaying state and the gas spraying state, whereby the same nozzle can be used in the liquid spraying state and in the gas spraying state. For this reason, it becomes feasible to reduce the number of nozzles and achieve simplification of the cleaning device.

Furthermore, the sprayer may further have a movable mechanism for making an orientation of at least the first nozzle changeable. This sprayer can optimize the orientation of the nozzle in conformity with the sealing mask and thereby adequately remove the extraneous substances in a shorter time.

Furthermore, the movable mechanism may have a power source for swinging at least the first nozzle. This cleaning device swings the first nozzle to change angles of collision of the liquid with the extraneous substances, whereby the extraneous substances can be adequately removed in a shorter time.

### Advantageous Effect of Invention

According to the present invention, it is feasible to provide the cleaning method and the cleaning device for the sealing mask, and the production method for the honeycomb structure capable of adequately removing the extraneous substances in a short time.

### BRIEF DESCRIPTION OF DRAWINGS

FIG. 1 is a perspective view of a honeycomb structure.

FIG. 2 is a cross-sectional view along the line II-II in FIG. 1.

FIG. 3 is a plan view of a sealing mask.

FIG. 4 is a cross-sectional view along the line IV-IV in FIG. 3.

FIG. 5 is a side view showing a schematic configuration of a first embodiment of the cleaning device according to the present invention.

FIG. 6 is a plan view of the cleaning device in FIG. 5.

FIG. 7 is a cross-sectional view showing an end portion of a support pillar.

FIG. 8 is a drawing showing pipelines connecting a liquid feed pump and a gas feed pump to nozzles.

FIG. 9 is a drawing showing sprayed regions of liquid or gas on the sealing mask.

FIG. 10 is a side view showing a schematic configuration of a second embodiment of the cleaning device according to the present invention.

FIG. 11 is a side view showing a schematic configuration of a third embodiment of the cleaning device according to the present invention.

FIG. 12 is a drawing showing sprayed regions in a case with an increased number of nozzles.

FIG. 13 is a drawing showing pipelines connecting the liquid feed pump and the gas feed pump to nozzles, in a case where the nozzles used in a liquid spraying state are provided separately from the nozzles used in a gas spraying state.

### DESCRIPTION OF EMBODIMENTS

Preferred embodiments of the present invention will be described below in detail with reference to the drawings. In the drawings, identical or equivalent portions will be denoted by the same reference signs, without redundant description.

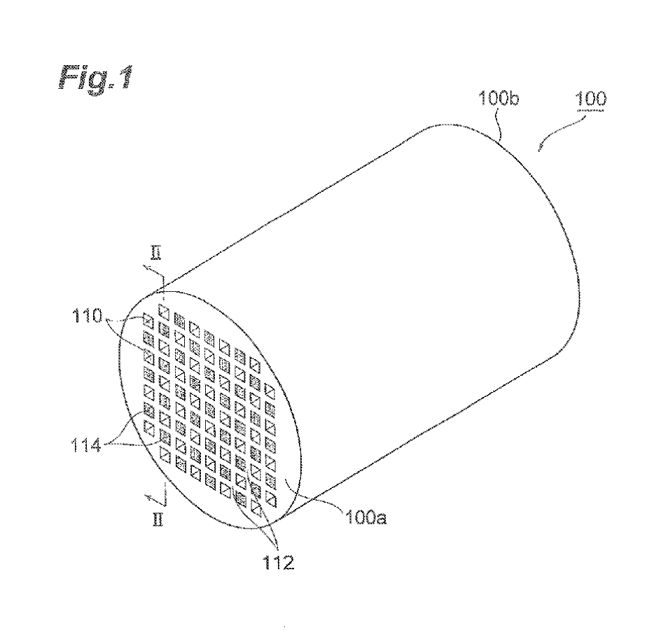

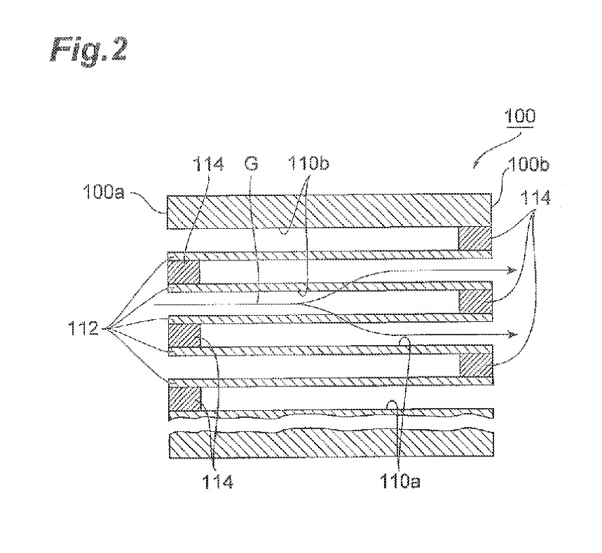

First, a honeycomb structure and a sealing mask will be described. FIG. 1 is a perspective view of the honeycomb structure. FIG. 2 is a cross-sectional view along the line II-II in FIG. 1. The honeycomb structure 100 shown in FIGS. 1 and 2 is a cylindrical member comprised of a porous ceramic material (e.g., with an average pore diameter of not more than 20 μm) or the like, and has a plurality of cells 110. Each of the cells 110 is a hole formed along the axial direction of the honeycomb structure 100 from an end face 100a to an end face 100b of the honeycomb structure 100. A porous partition wall 112 is formed between the cells 110. As shown in FIG. 2, predetermined cells 110a out of the plurality of cells 110 are plugged by a sealing material 114 on the end face 100a side. On the end face 100b side, the cells 110b other than the cells 110a out of the plurality of cells 110 are plugged by the sealing material 114.

The honeycomb structure 100 is used as a filter for cleaning up gas G emitted from an internal combustion engine. Specifically, the gas G is made to flow from the end face 100a to the end face 100b. The gas G is introduced into the cells 110b at the end face 100a, flows through the partition wall 112 into the cells 110a, and is then discharged from the cells 110a at the end face 100b. During this process, particulate substances (soot and others) contained in the gas G are captured by the partition wall 112, and thus the gas G is cleaned up.

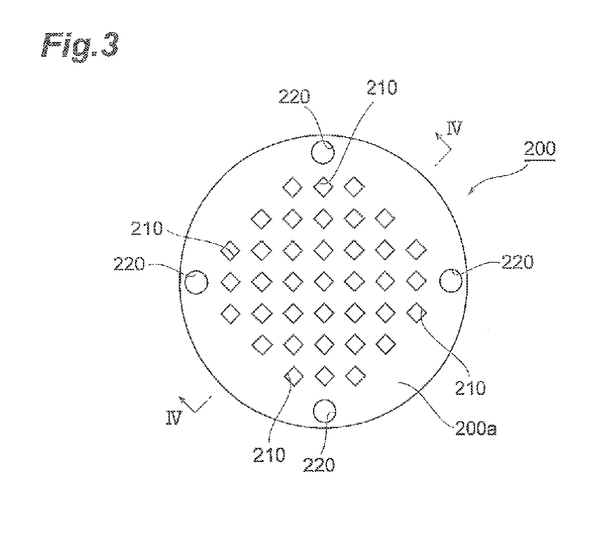

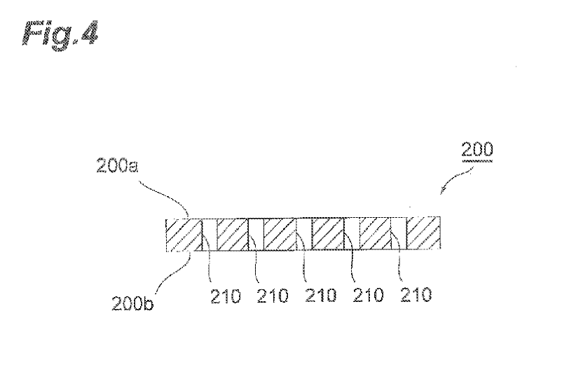

FIG. 3 is a plan view of a sealing mask. FIG. 4 is a cross-sectional view along the line IV-IV in FIG. 3. The sealing mask 200 shown in FIGS. 3 and 4 is arranged on the end face 100a side or on the end face 100b side of the honeycomb structure 100 on occasions of sealing the cells 110 in a production step of the honeycomb structure 100, so as to leave only the cells 110 to be plugged, open. The sealing mask 200 is a disk-like member having principal surfaces 200a, 200b opposed to each other, and a plurality of through-holes 210, 220 opening in the principal surfaces 200a, 200b. The principal surface 200a comes into contact with the end face 100a or the end face 100b of the honeycomb structure 100 on the occasions of sealing the cells 110. The through-holes 210 are formed at positions corresponding to the cells 110 to be plugged, so as to leave only the cells 110 to be plugged, open. This allows the sealing material 114 to be injected into only the cells 110 to be plugged. The through-holes 220 are formed at four locations along the circumferential direction on the outer periphery side of the sealing mask 200 and are used for positioning during cleaning as described below.

### First Embodiment

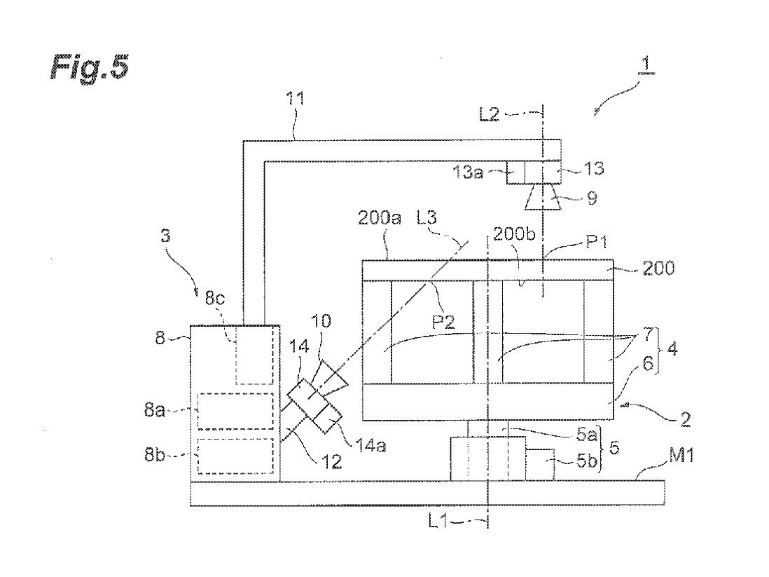

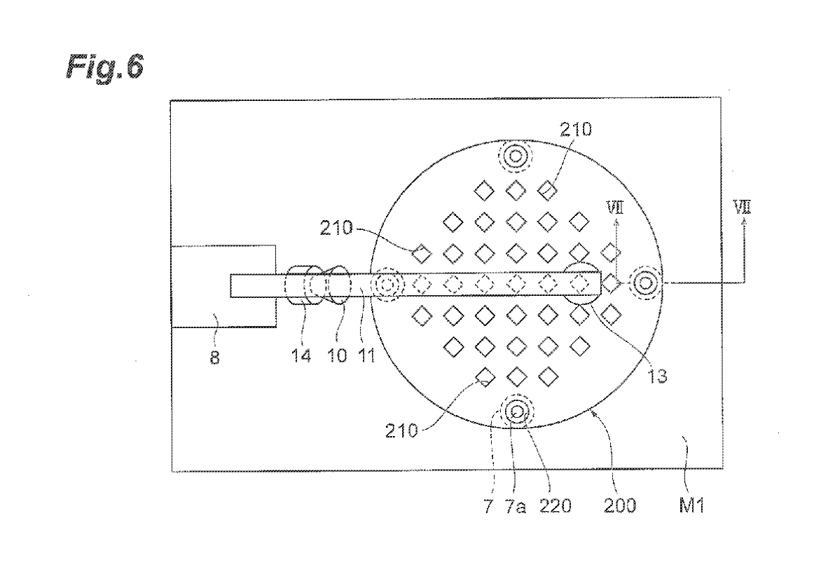

The below will describe a cleaning device for the sealing mask 200. FIG. 5 is a side view showing a schematic configuration of the first embodiment of the cleaning device according to the present invention. FIG. 6 is a plan view of the cleaning device in FIG. 5. As shown in FIGS. 5 and 6, the cleaning device 1 is provided with a rotator 2 for rotating the sealing mask 200, and a sprayer 3 for spraying a cleaning liquid on the sealing mask 200.

The rotator 2 has a support portion 4 for supporting the sealing mask 200, and a drive portion 5 for rotating the support portion 4. The drive portion 5 is set up on a floor surface M1. The drive portion 5 has a nearly-vertical rotation shaft 5a, and a power source 5b such as a motor for rotating the rotation shaft 5a. The support portion 4 has a rotary plate 6 horizontally set up on the drive portion 5, and four support pillars 7 projecting upward from the rotary plate 6. The rotary plate 6 is coupled to an upper end of the rotation shaft 5a and has a circular shape centered at a central axis L1 of the rotation shaft 5a. The support pillars 7 are arranged along the circumstantial direction on the outer periphery side of the rotary plate 6. Since the rotary plate 6 is coupled to the rotation shaft 5a, the support portion 4 rotates together with the rotation shaft 5a around the central axis L1.

The sealing mask 200 is set in an approximately horizontal state on the support pillars 7. The sealing mask 200 may be set with either of the principal surfaces 200a, 200b facing up, but it is assumed herein to be set with the principal surface 200a facing up. As shown in FIG. 6, the through-holes 220 of the sealing mask 200 correspond to the respective support pillars 7. It is noted that the number and arrangement of the support pillars 7 and through-holes 220 are appropriately changed depending upon the size and shape of the sealing mask 200.

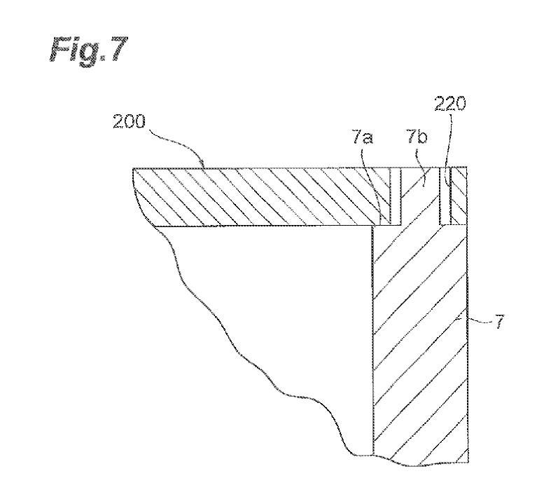

FIG. 7 is a cross-sectional view showing an end portion of the support pillar. As shown in FIG. 7, an upwardly-projecting positioning projection 7b is provided on an end face 7a of the support pillar 7. The positioning projections 7b are inserted into the respective through-holes 220. Because of this, the position of the sealing mask 200 is determined relative to the support portion 4 and the sealing mask 200 rotates together with the support portion 4. Namely, the sealing mask 200 rotates around the central axis L1 intersecting with the principal surfaces 200a, 200b.

As shown in FIG. 5, the sprayer 3 has a main body portion 8 set next to the rotator 2 on the floor surface M1, a nozzle 9 (first nozzle) located above the sealing mask 200, a nozzle 10 (second nozzle) located below the sealing mask 200, an arm 11 coupling the nozzle 9 to the main body portion 8, an arm 12 coupling the nozzle 10 to the main body portion 8, a movable mechanism 13 for making an orientation of the nozzle 9 changeable, and a movable mechanism 14 for making an orientation of the nozzle 10 changeable.

The main body portion 8 has a liquid feed pump 8a for pumping a liquid, a gas feed pump 8b for pumping a gas, and an arm drive portion 8c for driving the arm 11. The arm 11 is driven by the arm drive portion 8c to move the nozzle 9, whereby it becomes feasible to readily perform attachment/detachment of the sealing mask 200 to or from the support portion 4.

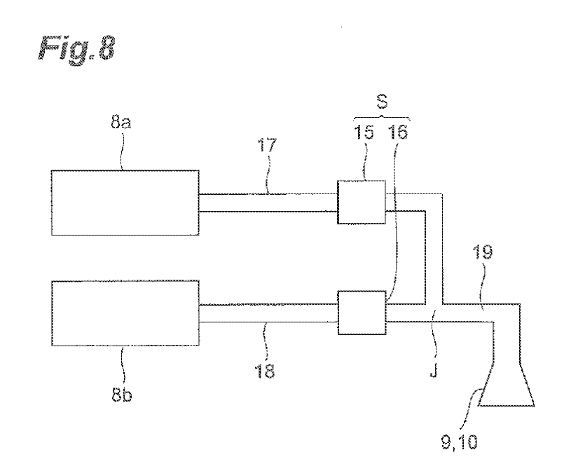

Each of the nozzles 9, 10 sprays the liquid and the gas pumped from the liquid feed pump 8a and the gas feed pump 8b. FIG. 8 is a schematic view showing a relation of the liquid feed pump and the gas feed pump with the nozzles. As shown in FIG. 8, a liquid feed pipeline 17 is provided between the liquid feed pump 8a and the nozzle 9, 10 and a gas feed pipeline 18 is provided between the gas feed pump 8b and the nozzle 9, 10. The liquid feed pipeline 17 and the gas feed pipeline 18 are joined near the nozzle 9, 10 and a common pipeline 19 is provided between a joint J thereof and the nozzle 9, 10. The liquid pumped from the liquid feed pump 8a and the gas pumped from the gas feed pump 8b flow through the liquid feed pipeline 17 and through the gas feed pipeline 18, respectively, to merge at the joint J and then to be sprayed through the common pipeline 19 from the nozzle 9, 10. The liquid feed pipeline 17, gas feed pipeline 18, and common pipeline 19 are guided inside the arms 11, 12.

A solenoid valve 15 is provided midway of the liquid feed pipeline 17 and a solenoid valve 16 midway of the gas feed pipeline 18. When the solenoid valves 15, 16 are opened, the liquid and the gas flow through the common pipeline 19 to be sprayed from the nozzle 9, 10. Namely, the sprayer goes into a liquid spraying state in which the cleaning liquid is sprayed from the nozzle 9, 10. When the solenoid valve 15 is closed and only the solenoid valve 16 is opened, only the gas flows through the common pipeline 19 to be sprayed from the nozzle 9, 10. Namely, the sprayer goes into a gas spraying state in which the gas for removal of the liquid is sprayed from the nozzle 9, 10. In this manner, the solenoid valves 15, 16 constitute a switching device S for implementing switching between the liquid spraying state and the gas spraying state. Since this allows the same nozzle 9, 10 to be used in the liquid spraying state and the gas spraying state, the number of nozzles 9, 10 is reduced, thereby achieving simplification of the cleaning device 1. The cleaning device may be configured to open only the solenoid valve 15 in the liquid spraying state to spray only the liquid.

As shown in FIG. 5, the nozzle 9 is located on the opposite side to the main body portion 8 with respect to the central axis L1 and opens downward so as to face the principal surface 200a of the sealing mask 200. A central axis L2 of the nozzle 9 intersects with the principal surface 200a and an intersection point P1 between the central axis L2 and the principal surface 200a is located on the opposite side to the main body portion 8 with respect to the central axis L1. By this, the liquid sprayed from the nozzle 9 is made to reach a region centered at the intersection point P1 on the principal surface 200a.

The nozzle 10 is located between the main body portion 8 and the rotator 2 and opens obliquely upward so as to face the principal surface 200b of the sealing mask 200. Namely, the nozzle 10 is located on the same side as the main body portion 8 with respect to the central axis L1. A central axis L3 of the nozzle 10 intersects with the principal surface 200b and an intersection point P2 between the central axis L3 and the principal surface 200b is located on the same side as the main body portion 8 with respect to the central axis L1. For this reason, the intersection point P1 and the intersection point P2 are located on the opposite sides to each other with respect to the central axis L1. The liquid sprayed from the nozzle 10 passes between the support pillars 7 of the support portion 4 and reaches a region centered at the intersection point P2 on the principal surface 200b.

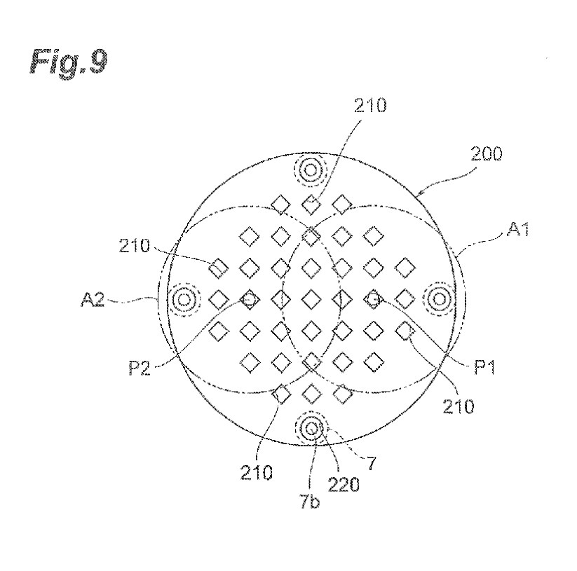

FIG. 9 is a drawing showing the sprayed regions of the liquid or the gas on the sealing mask. As shown in FIG. 9, the nozzle 9 sprays the liquid or the gas on the region A1 centered at the intersection point P1 on the principal surface 200a. The nozzle 10 sprays the liquid or the gas on the region A2 centered at the intersection point P2 on the principal surface 200b. As described above, the intersection point P1 and the intersection point P2 are located on the opposite sides to each other with respect to the central axis L1. Namely, the position of the intersection point P1 and the position of the intersection point P2 are different from each other when viewed from a direction parallel to the central axis L1. For this reason, the region A1 and the region A2 deviate from each other when viewed from the direction parallel to the central axis L1. In this manner, the region A1 and the region A2 are arranged with deviation, by the simple configuration wherein the nozzles 9, 10 are located at the mutually different positions when viewed from the direction parallel to the central axis L1.

The movable mechanism 13 is interposed between the end of the arm 11 and the nozzle 9. The movable mechanism 13 has a power source 13a such as a motor for swinging the nozzle 9. The movable mechanism 14 is interposed between the end of the arm 12 and the nozzle 10. The movable mechanism 14 has a power source 14a such as a motor for swinging the nozzle 10.

The below will describe a cleaning method for the sealing mask 200 using the cleaning device 1. First, the sealing mask 200 which has been used for sealing and to which extraneous substances are attached is set on the support portion 4. On this occasion, the arm 11 is driven by the arm drive portion 8c of the main body portion 8 to move the nozzle 9 from above the support portion 4, whereby the sealing mask 200 can be readily set.

Next, the support portion 4 and the sealing mask 200 are rotated around the central axis L1 by the drive portion 5. Then, while the sealing mask 200 is rotated, the solenoid valves 15, 16 are opened to spray the cleaning liquid on the principal surfaces 200a, 200b, respectively, from the nozzles 9, 10. Through this process, the sealing mask 200 is rotated around the central axis L1 intersecting with the principal surfaces 200a, 200b, whereby the liquid is evenly sprayed over the whole of the principal surfaces 200a, 200b. Since the rotating speed of the sealing mask 200 is added to the moving speed of the liquid, the force exerted on the extraneous substances by collision of the liquid is enhanced. Furthermore, the liquid and extraneous substances are blown away by centrifugal force to the outside of the sealing mask 200. Therefore, the extraneous substances can be adequately removed in a short time.

In addition, since the liquid is sprayed on each of the principal surfaces 200a, 200b, the extraneous substances can be adequately removed in a shorter time.

The liquid is sprayed on each of the principal surfaces 200a, 200b so that the region A1 sprayed with the liquid on the principal surface 200a and the region A2 sprayed with the liquid on the principal surface 200b deviate from each other when viewed from the direction parallel to the central axis L1. For this reason, the liquid can be simultaneously sprayed on the wider regions when viewed from the direction parallel to the central axis L1, whereby the extraneous substances can be adequately removed in a shorter time.

The orientations of the nozzles 9, 10 may be changed by the movable mechanism 13 and the movable mechanism 14 to optimize the orientations of the nozzles 9, 10 in conformity with the sealing mask 200. This allows the extraneous substances to be adequately removed in a shorter time.

For example, the orientations of the nozzles 9, 10 may be adjusted by the movable mechanisms 13, 14 to spray the liquid so that a drag acts on the rotating sealing mask 200. Namely, the liquid may be sprayed on the sealing mask 200 so that a force opposite to the rotating direction acts thereon. Specifically, the orientations of the nozzles 9, 10 are adjusted so that the moving direction of the principal surfaces 200a, 200b with rotation of the sealing mask 200 and the spraying direction of the liquid from the nozzles 9, 10 are opposite to each other. This further enhances the force exerted on the extraneous substances by collision of the liquid. Therefore, the extraneous substances can be adequately removed in a shorter time.

Furthermore, the nozzles 9, 10 may be swung by the power sources 13a, 14a of the movable mechanisms 13, 14. This varies angles of collision of the liquid with the extraneous substances, whereby the extraneous substances can be adequately removed in a shorter time.

Next, the solenoid valves 15 are closed to spray the gas for removal of the liquid on the principal surfaces 200a, 200b, respectively, from the nozzles 9, 10. The sealing mask 200 is rotated around the central axis L1 intersecting with the principal surfaces 200a, 200b, whereby the gas is evenly sprayed over the whole of the principal surfaces 200a, 200b. Since the rotating speed of the sealing mask 200 is added to the moving speed of the gas, the force exerted on the liquid by the spraying of the gas is enhanced. Furthermore, the liquid is blown away by centrifugal force to the outside of the sealing mask 200. Therefore, the liquid remaining on the sealing mask 200 can be removed in a short time.

Next, the solenoid valves 16 are closed to halt the spraying of the gas, the rotation of the support portion 4 by the drive portion 5 is stopped, and the sealing mask 200 is detached. On this occasion, the arm 11 is also driven by the arm drive portion 8c of the main body portion 8 to move the nozzle 9 from above the sealing mask 200, whereby the sealing mask 200 can be readily detached.

The sealing mask 200 cleaned in this manner is reused for sealing of the honeycomb structure 100. In the reuse, since the extraneous substances are adequately removed from the sealing mask 200, the plugged state of the honeycomb structure 100 can be made stable. In addition, since the extraneous substances on the sealing mask 200 are removed in a short time, a time for awaiting completion of cleaning of the sealing mask 200 becomes shorter, and thus the production efficiency of the honeycomb structure 100 can be enhanced.

### Second Embodiment

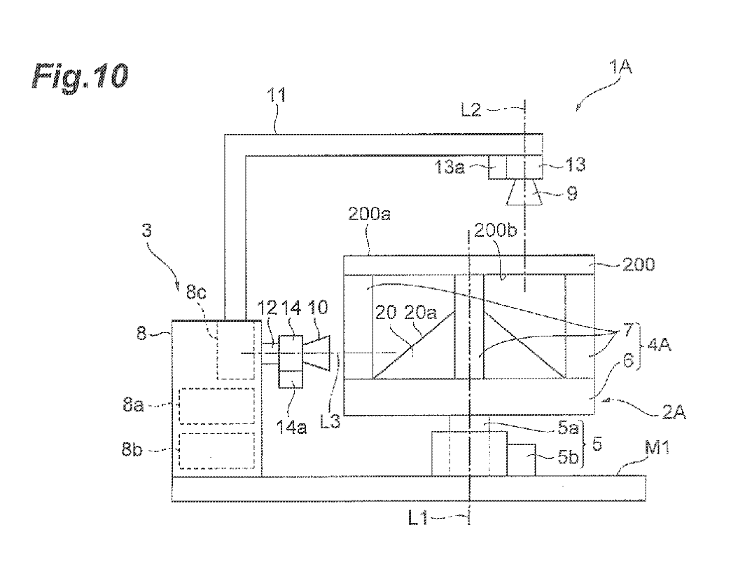

The below will describe the second embodiment of the cleaning device according to the present invention. FIG. 10 is a side view showing a schematic configuration of the second embodiment of the cleaning device according to the present invention. The cleaning device 1A shown in FIG. 10 is one configured to reflect the liquid or the gas sprayed from the nozzle 10 so as to reach the principal surface 200b of the sealing mask 200.

A rotator 2A of the cleaning device 1A has a support portion 4A instead of the support portion 4. The support portion 4A is one obtained by providing a bump 20 of a conical shape, in a central region of the top surface of the rotary plate 6 in the support portion 4. The nozzle 10 opens laterally so as to face a conical face 20a of the bump 20. The angle of the conical face 20a and the arrangement of the nozzle 10 are adjusted so that the liquid or the gas sprayed along the central axis L3 of the nozzle 10 is reflected by the conical face 20a so as to reach the principal surface 200b of the sealing mask 200 on the same side as the main body portion 8 with respect to the central axis L1.

Since the cleaning device 1A can spray the liquid on the principal surface 200b without need for directing the nozzle 10 to the principal surface 200b of the sealing mask 200, it increases degrees of freedom for the arrangement of the nozzle 10. In addition, since the liquid can be sprayed approximately perpendicularly to the principal surface 200b, the extraneous substances can be adequately removed in a shorter time.

### Third Embodiment

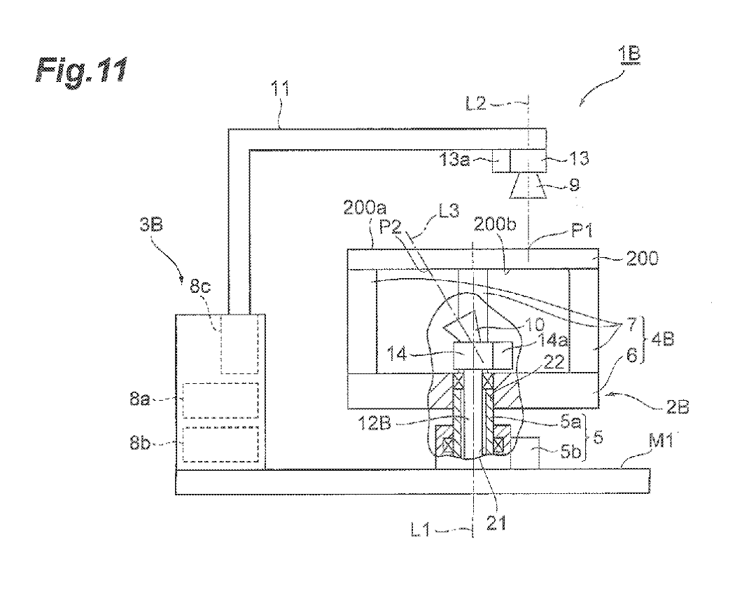

The below will describe the third embodiment of the cleaning device according to the present invention. FIG. 11 is a side view showing a schematic configuration of the third embodiment of the cleaning device according to the present invention. The cleaning device 1B shown in FIG. 11 is one in which the nozzle 10 is arranged inside the support portion 4.

The cleaning device 1B is provided with a rotator 2B and a sprayer 3B instead of the rotator 2 and the sprayer 3. The sprayer 3B has an arm 12B instead of the arm 12. The rotator 2B has a support portion 4B instead of the support portion 4. The support portion 4B has a through-hole 21 provided in the rotation shaft 5a along the central axis L1, and an opening 22 provided in a central portion of the rotary plate 6 and exposing an upper end portion of the through-hole 21. The arm 12B extends from the main body portion 8 and passes through the through-hole 21 from bottom to top. The arm 12B is not fixed to the rotation shaft 5a and thus the arm 12B does not rotate even with rotation of the support portion 4B.

The nozzle 10 is coupled to the upper end of the arm 12B through the movable mechanism 14, located on the central axis L1, and surrounded by the support pillars 7. The nozzle 10 opens obliquely upward and the intersection point P2 between the central axis L3 of the nozzle 10 and the principal surface 200b is located on the same side as the main body portion 8 with respect to the central axis L1.

The cleaning device 1B is configured so that the liquid sprayed from the nozzle 10 reaches the principal surface 200b without passing between the pillars 7 of the support portion 4. For this reason, the whole of the liquid sprayed toward the principal surface 200b reaches the principal surface 200b, without colliding with the support pillars 7. Therefore, the extraneous substances can be adequately removed in a shorter time.

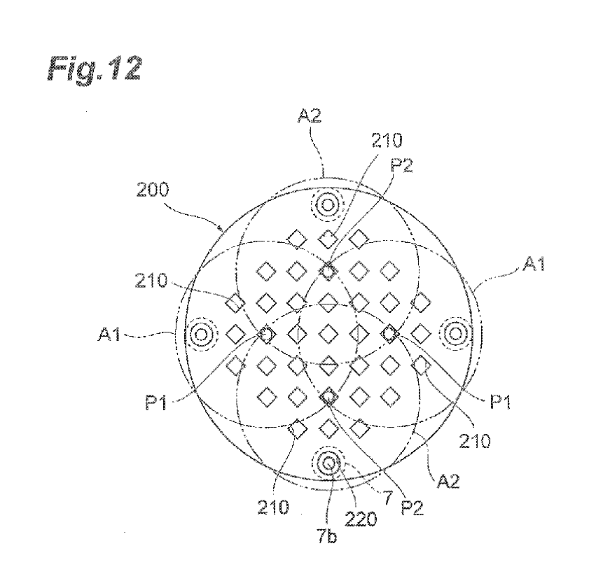

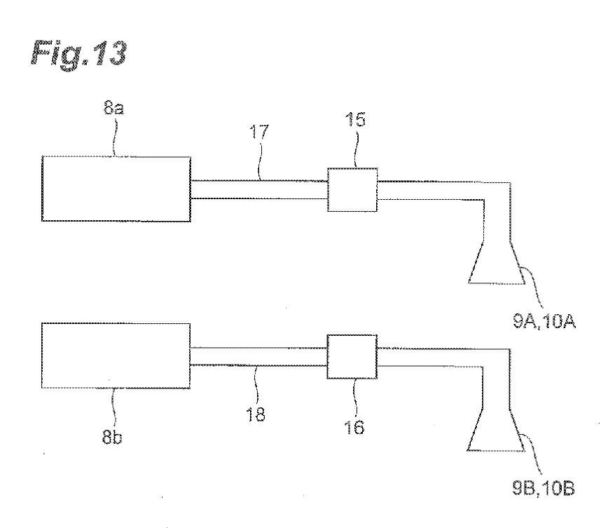

The above descried the preferred embodiments of the present invention, but it should be understood that the present invention is not always limited to the above-described embodiments and can be modified in many ways without departing from the spirit and scope of the invention. For example, the number of nozzles 9, 10 may be suitably increased or decreased, and it is possible to provide the first nozzle, second nozzle, third nozzle, fourth nozzle, fifth nozzle, sixth nozzle, seventh nozzle, eighth nozzle, ninth nozzle, tenth nozzle, and so on. By increasing the number of nozzles, it becomes feasible to reduce the cleaning time per mask. FIG. 12 is a drawing showing sprayed regions in a case where the nozzles 9, 10 are increased each to two nozzles. In FIG. 12, the regions A1, A1 sprayed on the principal surface 200a with the liquid from the nozzles 9, 9 and the regions A2, A2 sprayed on the principal surface 200b with the liquid from the nozzles 10, 10 deviate from each other. This allows the liquid to be simultaneously sprayed on the much wider range. As shown in FIG. 13, the nozzles 9A, 10A used in the liquid spraying state may be provided separately from the nozzles 9B, 10B (third nozzles) used in the gas spraying state.

### INDUSTRIAL APPLICABILITY

The present invention is applicable to production of the honeycomb structure for cleaning up the gas emitted from the internal combustion engine.

### REFERENCE SIGNS LIST

1, 1A, 1B cleaning device; 2, 2A, 2B rotator; 3, 3B sprayer; 9, 9A nozzle (first nozzle); 10, 10A nozzle (second nozzle); 9B, 10B nozzles 10 (third nozzles); 13, 14 movable mechanisms; 13a, 14a power sources; 100 honeycomb structure; 200 sealing mask; 200a principal surface; 200b principal surface; 210 through-holes; A1, A2 regions; L1 central axis; S switching device.

1. A cleaning method for a sealing mask having one principal surface and the other principal surface opposed to each other and a plurality of through-holes opening in the one principal surface and the other principal surface, the sealing mask for sealing a predetermined cell out of a plurality of cells in a honeycomb structure, the cleaning method comprising:
spraying a cleaning liquid on at least the one principal surface, while rotating the sealing mask around an axis intersecting with the one principal surface and the other principal surface.

2. The cleaning method for a sealing mask according to claim 1, wherein the liquid is sprayed on each of the one principal surface and the other principal surface.

3. The cleaning method for a sealing mask according to claim 2, wherein the liquid is sprayed on each of the one principal surface and the other principal surface so that a region sprayed with the liquid on the one principal surface and a region sprayed with the liquid on the other principal surface deviate from each other when viewed from a direction parallel to the axis.

4. The cleaning method for a sealing mask according to claim 1, wherein the liquid is sprayed on at least the one principal surface so that a drag acts on the rotating sealing mask.

5. The cleaning method for a sealing mask according to claim 1, comprising: after spraying the liquid on at least the one principal surface, spraying a gas for removal of the liquid on at least the one principal surface, while rotating the sealing mask around the axis.

6. A production method for a honeycomb structure, comprising: sealing the predetermined cell in the honeycomb structure, using the sealing mask cleaned with the use of the cleaning method for a sealing mask according to claim 1.

7. A cleaning device for a sealing mask having one principal surface and the other principal surface opposed to each other and a plurality of through-holes opening in the one principal surface and the other principal surface, the sealing mask for sealing a predetermined cell out of a plurality of cells in a honeycomb structure, the cleaning device comprising:
a rotator configured to support the sealing mask and rotate the sealing mask around an axis intersecting with the one principal surface and the other principal surface; and
a sprayer having a first nozzle for spraying a cleaning liquid on the one principal surface.

8. The cleaning device for a sealing mask according to claim 7, wherein the sprayer further has a second nozzle for spraying the liquid on the other principal surface.

9. The cleaning device for a sealing mask according to claim 8, wherein the first nozzle and the second nozzle spray the liquid on the one principal surface and on the other principal surface, respectively, so that a region sprayed with the liquid on the one principal surface and a region sprayed with the liquid on the other principal surface deviate from each other when viewed from a direction parallel to the axis.

10. The cleaning device for a sealing mask according to claim 9, wherein the first nozzle and the second nozzle are arranged at mutually different positions when viewed from the direction parallel to the axis.

11. The cleaning device for a sealing mask according to claim 7, wherein at least the first nozzle sprays the liquid on the one principal surface so that a drag acts on the rotating sealing mask.

12. The cleaning device for a sealing mask according to claim 7, wherein the sprayer further has a third nozzle for spraying a gas for removal of the liquid, on at least the one principal surface.

13. The cleaning device for a sealing mask according to claim 7, wherein the sprayer further has a switching device for implementing switching between a liquid spraying state for spraying the liquid from at least the first nozzle and a gas spraying state for spraying a gas for removal of the liquid from at least the first nozzle.

14. The cleaning device for a sealing mask according to claim 7, wherein the sprayer further has a movable mechanism for making an orientation of at least the first nozzle changeable.

15. The cleaning device for a sealing mask according to claim 14, wherein the movable mechanism has a power source for swinging at least the first nozzle.
